(19) United States
(12) Patent Application Publication
(10) Pub. No.: US 2025/0306170 A1
(43) Pub. Date: Oct. 2, 2025

(54) METHOD AND APPARATUS FOR ESTIMATING TIME DELAY BETWEEN EXCITATION SIGNAL AND STIMULATED SIGNAL

(71) Applicant: Telefonaktiebolaget LM Ericsson (publ), Stockholm (SE)

(72) Inventors: Jinsong Yang, Beijing (CN); Hao Ye, Beijing (CN); Haiying Cao, Beijing (CN); Peng Liu, Beijing (CN)

(21) Appl. No.: 18/869,332

(22) PCT Filed: May 30, 2022
(86) PCT No.: PCT/CN2022/095975

§ 371 Date: Nov. 26, 2024

(51) Int. Cl. G01S 7/40; G01S 7/52; H04B 1/04

(52) U.S. Cl. CPC G01S 7/4065; G01S 7/4004; G01S 7/4069; G01S 7/52004; H04B 1/04; H04B 2001/0425

(57) ABSTRACT

The present disclosure generally relates to signal processing, and more specifically, the embodiments herein relate to a method for estimating a time delay between an excitation signal and a stimulated signal correlated with the excitation signal in a communication or measurement system, an apparatus and computer program product adapted for the same purpose. In one or more embodiments according to the present disclosure, there proposes a method for estimating a time delay between an excitation signal and a stimulated signal correlated with the excitation signal in a communication or measurement system. In the method, it acquires a predictive offset with which the stimulated signal is predicted to be approximately synchronized with the excitation signal. Then, the cross-correlation between the excitation signal and the stimulated signal with the predictive offset is acquired and the time delay is determined from the cross-correlation.

### TECHNICAL FIELD

The present disclosure generally relates to signal processing, and more specifically, the embodiments herein relate to a method for estimating a time delay between an excitation signal and a stimulated signal correlated with the excitation signal in a communication or measurement system, an apparatus and computer program product adapted for the same purpose.

### BACKGROUND

Passive intermodulation (PIM) is a type of distortion generated by non-linearity of passive components, such as filters, duplexers, connectors, antennas and so forth at a cell site. Traditionally, PIM is a critical issue for a radio system with multi-band capabilities.

PIM distortion degrades reception (RX) sensitivity and signal to interference plus noise ratio (SINR). PIM cancellation (PIMC) is introduced to reduce RX SINR distortion by synchronizing RX signal with transmission (TX) signal. In order to determine a cancellation start point, it requires performing time delay estimation (TDE) between the TX and RX signals. In PIMC algorithms, the time delay is a critical parameter.

In a radio system, PIM signal strength possibly changes within a large range. When PIM signals are relatively strong, the TDE can achieve good accuracy and the convergency process is quick. But for those weak counterparts, the process will become very slow and the accuracy may degrade significantly as the correlation peak(s) is submerged in noise floor or RX signals.

FIGS. 1 and 2 illustrate exemplary cross-correlation spectra for strong and weak PIM signals respectively. In both examples, cross-correlation operations are performed with 300 times of iteration. As shown in FIG. 1, the maximum peak is outstanding around the 480^{th} data sample or cycle of the RX signal and corresponds to the actual time delay. In contrast, it can be seen from FIG. 2 that several peaks with very close amplitude occur, and thus the one corresponding to the actual time delay is indistinguishable from other peaks.

### SUMMARY

The present disclosure proposes solutions to improve the accuracy and speed up the convergence rate in time delay estimating between a pair of correlative signals.

In one or more embodiments according to the present disclosure, there proposes a method for estimating a time delay between an excitation signal and a stimulated signal correlated with the excitation signal in a communication or measurement system. In the method, it acquires a predictive offset with which the stimulated signal is predicted to be approximately synchronized with the excitation signal. Then, the cross-correlation between the excitation signal and the stimulated signal with the predictive offset is acquired and the time delay is determined from the cross-correlation.

In some embodiments, in the method, it further sets the time delay as the predictive offset for subsequent time delay estimation.

In some embodiments, the time delay may be used for carrying out one of passive intermodulation cancellation (PIMC) in a base station, digital pre-distortion (DPD), antenna calibration, direction of arrival (DOA) estimation, voice echo cancellation for cell phone, and noise cancellation in a sonar system or a radar system.

In some embodiments, if any previously determined time delay between the excitation signal and the stimulated signal is available, it setts the previously determined time delay as the predictive offset, and if no previously determined time delay between the excitation signal and the stimulated signal is available, it sets initial offset as the predictive offset.

In some embodiments, the initial offset may be a passive intermodulation (PIM) loop delay measured at transceiver array boundary (TAB) or Radiated Interface Boundary (RIB) or is determined based on a loop delay range.

In some embodiments, it acquires a first plurality of data samples of the excitation signal starting at a first point and a second plurality of data samples of the stimulated signal and then performs the cross-correlation on the first plurality of data samples and the second plurality of data samples over the delay window. Particularly, the second plurality of data samples corresponds to a delay window starting at a second point being later than the first point roughly by the predictive offset.

In some embodiments, the length of the excitation signal is less than or equal to the length of the stimulated signal.

In some embodiments, the first and second plurality of data samples are acquired by capturing the excitation signal and the stimulated signal synchronously and then intercepting the stimulated signal from the second point to acquire the second plurality of data samples corresponding to the delay window.

In some embodiments, the first and second plurality of data samples are acquired by capturing the first plurality of data samples and capturing the stimulated signal with a delay roughly equal to the predictive offset so as to acquire the second plurality of data samples corresponding to the delay window.

In some embodiments, the second point is selected so as to make the delay window cover one or more possible PIM sources.

In some embodiments, the cross-correlation is in the form of power correlation or signal correlation in a baseband or an intermodulation signal.

In some embodiments, the time delay is determined by performing a scaling processing on the cross-correlation, positioning a correlation peak having the greatest amplitude in the scaled cross-correlation and determining the time delay on the basis of a location corresponding to the correlation peak having the greatest amplitude and in relation to the predictive offset.

In one or more embodiments according to the present disclosure, there proposes an apparatus for estimating a time delay between an excitation signal and a stimulated signal correlated with the excitation signal in a communication or measurement system. The apparatus comprises memory configured to store a computer program comprising computer instructions and at least one processor coupled to the memory. In the apparatus, the at least one processor is configured to execute the computer instructions to acquire a predictive offset with which the stimulated signal is predicted to be approximately synchronized with the excitation signal, acquire cross-correlation between the excitation signal and the stimulated signal with the predictive offset, and determine the time delay from the cross-correlation.

In one or more embodiments according to the present disclosure, there proposes a computer program product being embodied in a computer readable storage medium and comprising computer instructions for carrying out the steps of the above methods.

In some embodiments according to the present disclosure, it slides the stimulated signal, e.g., RX signal, roughly with the predictive offset in the cross-correlation calculation. The sliding may facilitate quickly positioning the correlation peak corresponding to the time delay and making the peak more prominent with the less times of iteration, especially when the PIM signal is weak. Moreover, for a stable channel environment, it is advantageous to set the previous time delay as the predictive offset so as to further speed up the convergency of the iteration process.

In some embodiments, the position of the delay window is adjustable to only cover possible PIM source locations so that it can discard useless data in the cross-correlation calculation.

It shall be noted that the solutions according to the present disclosure can provide approaches having versatility and scalability in improving performance of a variety of synchronization algorithms.

### BRIEF DESCRIPTION ON DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 illustrates an example of cross-correlation for strong weak PIM.

FIG. 2 illustrates an example of cross-correlation for weak PIM.

FIG. 3 illustrates a plurality of PIM sources in a radio system 300, e.g., base station.

FIG. 4 illustrates a timing relationship between TX signal and RX signal.

FIG. 5 illustrates the effect of the PIM measurement selection on the initial offset for RX signal.

FIG. 6 illustrates an example of determining a time window according to some embodiments of the present disclosure.

FIG. 7 illustrates another example of determining a time window according to some embodiments of the present disclosure.

FIG. 8 is a schematic flow chart illustrating an exemplary method 800 according to one or more embodiments of the present disclosure.

FIG. 9 is a schematic flow chart illustrating an exemplary method 900 according to one or more embodiments of the present disclosure.

FIG. 10 illustrates an example of the acquisition of the TX and RX signals according to one or more embodiments of the present disclosure.

FIG. 11 is a schematic flow chart illustrating an exemplary method 1100 according to one or more embodiments of the present disclosure.

FIG. 12 illustrates an exemplary scaled cross-correlation spectrum.

FIG. 13 is a block diagram illustrating an apparatus for estimating a time delay between an excitation signal and a stimulated signal correlated with the excitation signal in a communication or measurement system according to one or more embodiments of the present disclosure.

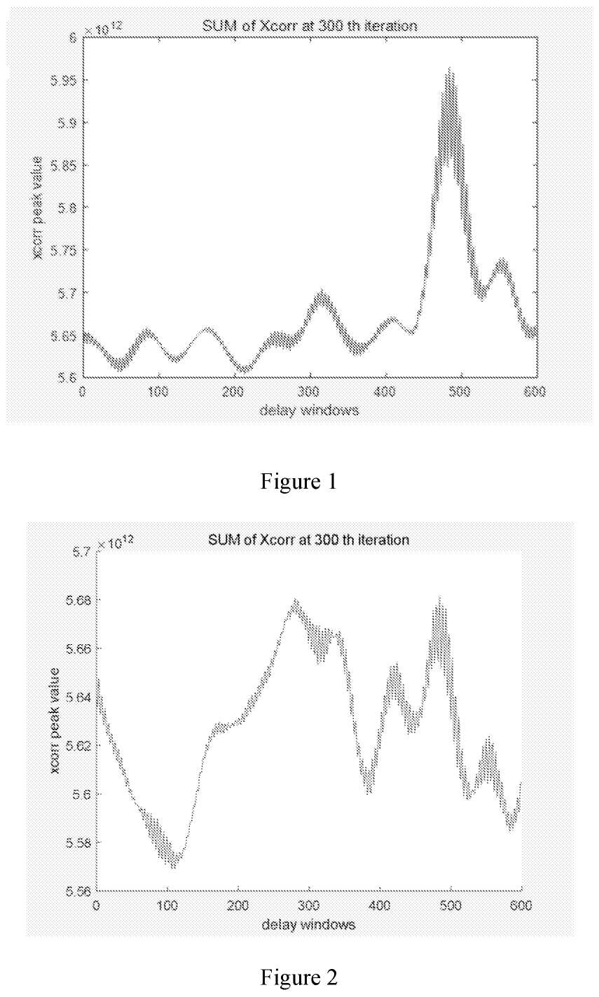

### DETAILED DESCRIPTION ON EMBODIMENTS

In the following detailed description, numerous specific details such as logic implementations, types and interrelationships of system components, etc., are set forth in order to provide a more thorough understanding of the present disclosure. It should be noted, however, by those skilled artisans in the art that the present disclosure may be practiced without such specific details. In other instances, control structures, circuits and instruction sequences have not been shown in detail in order not to obscure the present disclosure. Those skilled artisans in the art, with the included descriptions, will be able to implement appropriate functionality without undue experimentation.

References in the disclosure to “one embodiment”, “an embodiment”, “an example embodiment” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of those skilled artisans in the art to affect such feature, structure, or characteristic in connection with other embodiments whether or not explicitly described.

In the following detailed description and claims, the phrase “A, B, or C” used herein means “A” or “B” or “C”; the phrase “A, B, and C” used herein means “A” and “B” and “C”; the phrase “A, B, and/or C” used herein means “A”, “B”, “C”, “A and B”, “A and C”, “B and C” or “A, B, and C”.

In the following detailed description and claims, the terms “coupled” and “connected”, along with their derivatives, may be used. It should be understood that these terms are not intended as synonyms for each other. “Coupled” is used for indicating that two or more elements, which may or may not be in direct physical or electrical contact with each other, cooperate or interact with each other. “Connected” is used to indicate the establishment of communication between two or more elements that are coupled with each other.

The embodiments herein can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In the present disclosure, these implementations, or any other form that the embodiments may take, may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

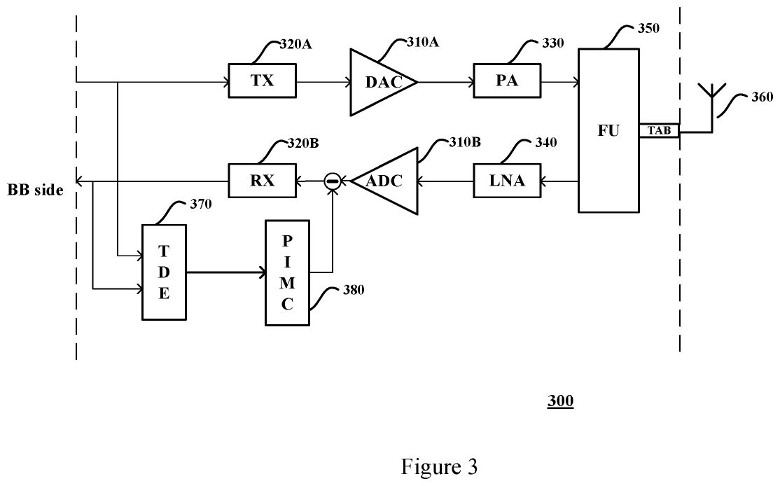

FIG. 3 illustrates a plurality of PIM sources in a radio system 300, e.g., base station.

In a typical radio system, TX and RX branches may be defined on per antenna per band in PIMC. For example, a triple band 4 antenna product can be defined as 12 TX and RX branches. Some TX branches are combined to generate PIM source to impact some RX branches. The TX branches and RX branches are called as aggressors and victims respectively. As shown in FIG. 3, for a pair of aggressor TX and victim RX, PIM loop delay estimation is carried out at TDE unit. The estimated delay is then output to PIMC unit which, in turn, determine a cancellation start point so as to synchronize RX signal with TX signal.

With reference to FIG. 3, a PIM loop delay may result from numerous PIM sources, which may locate inside or outside the radio system. In the example as shown in FIG. 3, the PIM loop delay may consist of a plurality of components over the whole wireless channel. In particular, the delay comprises downlink (DL) and uplink (UL) digital module delay (i.e., delay on DAC 310A and ADC 310B), transceiver delay on TX unit 320A and RX unit 320B, delay on power amplifier (PA) 330 and low noise amplifier (LNA) 340, delay on filter unit (FU) 350, delay on antenna 360, and air PIM signal transmission delay.

In an illustrative implementation, TDE unit 370 captures TX and RX data signals, which can be considered as a pair of an excitation signal and its correlated stimulation signal, simultaneously and stores the captured data into memory. In TDE, the excitation signal can be a data transmission signal in this embodiment as described herein. It can also be one captured at the TX portal. The stimulated signal correlated to the excitation signal is one captured simultaneously at the RX portal which is affected by the excitation signal. A TDE algorithm is performed to determine the PIM loop delay by calculating power correlation between the stored TX and RX data over a time window. Generally, depending on specific TX/RX circuit design and the channel environment, the PIM loop delay is in the range of about 1 μs to 3 μs. The PIM loop delay determined by TDU unit 370 is output to PIMC unit 380 for PIMC processing.

Typically, the accumulation of the cross-correlation is acquired by performing the cross-correlation calculation in an iterative manner so as to remove noise impact when positioning the peak corresponding to the actual delay (also referred to as “target peak” hereinafter) in the cross-correlation spectrum. However, for those weak PIM signals, the target peak is often indistinguishable from other peaks even after performing the iteration in depth.

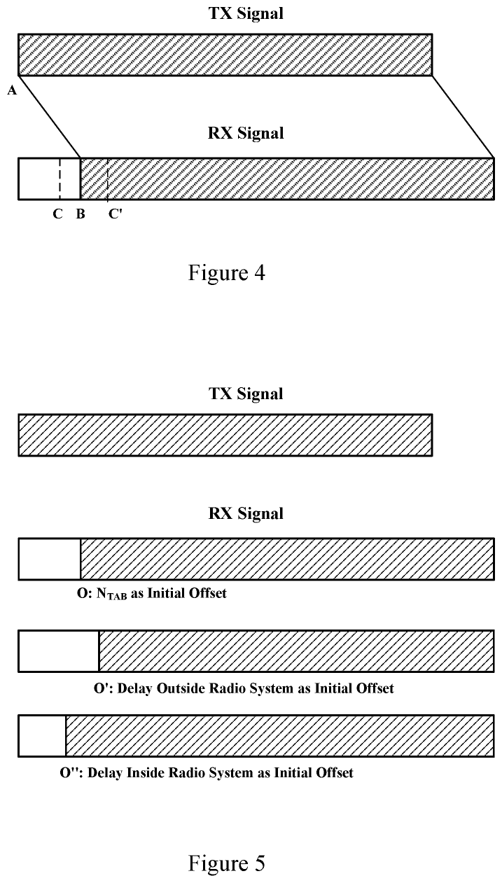

FIG. 4 illustrates a timing relationship between TX signal and RX signal. With reference to FIG. 4, the portion of the RX signal correlated with the TX signal lags behind the TX signal with a PIM loop delay. Thus, to achieve a complete PIMC, the start point B of the correlated portion of the RX signal needs to basically align with the start point A of the TX signal.

In some embodiments according to the present disclosure, the cross-correlation calculation is performed on TX signal and RX signal roughly with a predictive offset. Namely, the RX signal is shifted with a quantity which may be slightly less or more than the offset or equal to the offset. With this predictive offset the RX signal being shifted, the TX and RX signals are predicted or expected to approximately synchronize with each other. In the example shown in FIG. 4, the portion of the RX signal involved in the correlation calculation may start at a point around the point B, e.g., point C or C′.

To make the predictive offset close to the PIM loop delay or the actual delay, in some embodiments, the offset is set to be the actual delay as determined previously. On the other hand, if the previous delay is unavailable, the predictive offset may be set to be an initial offset.

With reference to FIG. 3, the initial offset may be set as a delay measured at transceiver array boundary (TAB), or it could also be measured at Radiated Interface Boundary (RIB). Furthermore, the initial offset may also be one selected from a loop delay range determined based on the loop delay measurement carried out previously.

FIG. 5 illustrates the effect of the PIM measurement selection on the initial offset for RX signal. As shown in FIG. 5, if it regards the start point O with a delay N_{TAB} measured at TAB as a neutral point, the selection of the delay measured internally will lead to a negative point O′, i.e., a reduced offset, and the selection of the delay measured externally will lead to a positive point O″, i.e., an increased offset.

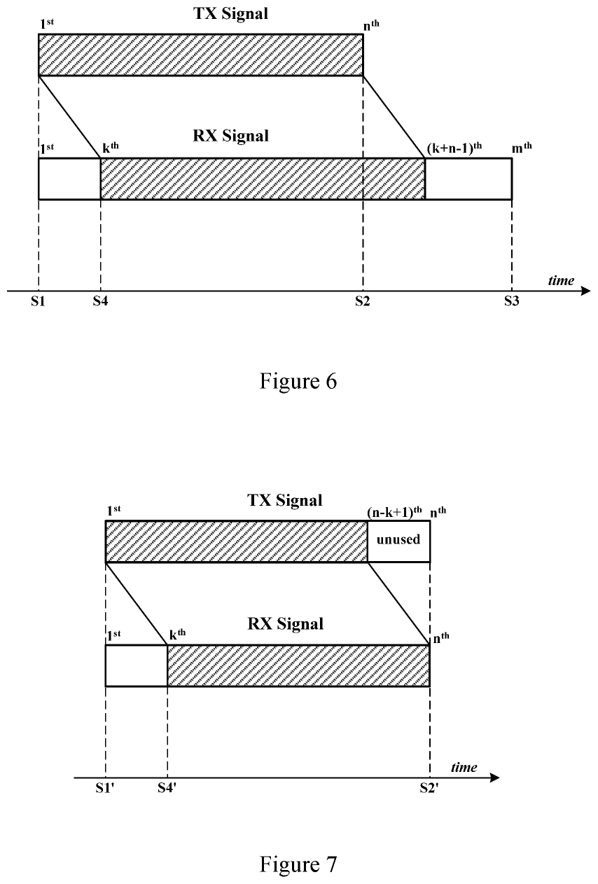

As noted above, the cross-correlation calculation is performed over a time window. In other words, the window defines which portion of RX signal is involved in the calculation. FIG. 6 illustrates an example of determining a time window according to some embodiments of the present disclosure. In this example, the length of the window is defined in terms of the quantity of data samples or cycles, and the boundary is defined in terms of the serial number of data samples. With reference to FIG. 6, TX signal as captured starts at time point S1 corresponding to its 1^{st} data sample and ends at time point S2 corresponding to its n^{th} data sample; RX signal as captured also starts at time point S1 corresponding to its 1^{st} data sample but ends at time point S3 corresponding to its m^{th} data sample. That is, the lengths of the TX and RX signals are n and m in terms of the data samples respectively. Only for illustrative purpose, the length of the time window may be set as n, i.e., to be equal to the length of the TX signal.

On the other hand, the portion of the RX signal correlated with the TX signal lags behind the TX signal with a PIM loop delay. As noted above, although the actual loop delay is unknown before the cross-correlation calculation, it may assume a predictive offset for the calculation. In the example as shown in FIG. 6, the predictive offset is set as k in terms of data samples or cycles. Thus, time point S4 corresponding to the k^{th} data sample of the RX signal may be selected as the start point of the correlated portion. That is, the correlated portion or the time window starts at the k^{th} data sample and ends at the (k+n−1)^{th} data sample. As noted above, the predictive offset may set to be the previous actual delay or the initial offset.

In the example as shown in FIG. 6, the length of the captured RX signal is greater than the length of the captured TX signal. For example, it may capture (n+k) RX data samples (i.e., m=n+k) and n TX data samples so that the whole of the TX signal is involved in the cross-correlation calculation. However, this is not essential. FIG. 7 illustrates another example of determining a time window according to some embodiments of the present disclosure where a part of the captured TX is unused. To be specific, as shown in FIG. 7, the TX and RX signals start at point S1′ corresponding to their 1^{st} data samples and ends at point S2′ corresponding to their nth data samples. In this example, the predictive offset is set as k in terms of data samples or cycles and point S4′ corresponding to the k^{th} data sample of the RX signal is selected as the start point of the correlated portion. Thus, the correlated portion or the time window starts at the k^{th} data sample and ends at the n^{th} data sample. Namely, (n—k+1) of the TX (RX) data samples are used in the cross-correlation calculation.

In some embodiments, the start point of the correlated portion may be set to deviate from the k^{th} data sample of the RX signal, e.g., the (k+Δ₁)^{th} data sample or the (k—Δ₂)^{th} data sample (Δ₁ and Δ₂>0) so as to cover possible PIM-related delays, e.g., those delays as shown in FIG. 3. Hereinafter, the time window acquired by shifting the RX signal roughly with a predictive offset is also referred to as “delay window”.

In some embodiments, the delay window is defined as an interval whose endpoints are represented by the serial numbers of data samples relative to a reference point corresponding to the predictive offset. Taking FIG. 6 as an example where the k^{th} data sample is considered as a reference point with a relative serial number of 0, a delay window denoted as [−100, 500] indicates that the window starts at one occurring with 100 data samples earlier than the reference point, and ends at one occurring with 500 samples later than the reference point.

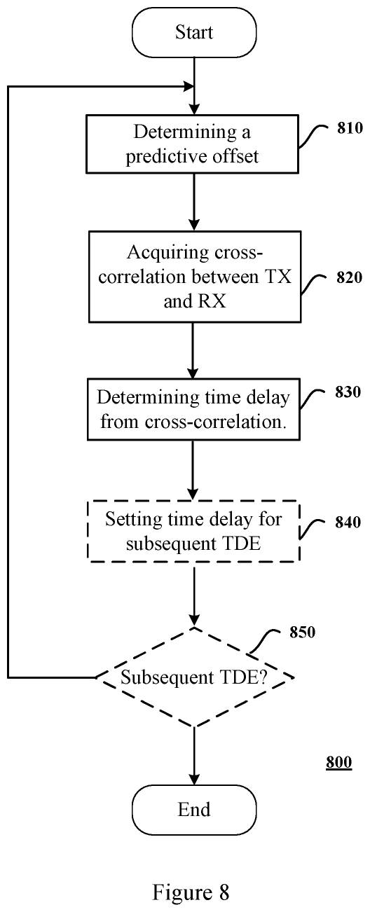

FIG. 8 is a schematic flow chart illustrating an exemplary method 800 according to one or more embodiments of the present disclosure. Only for illustrative purpose, the following description is made in the context of time delay estimation for PIMC in a base station, e.g., as shown in FIG. 3. However, the exemplary method is applicable to other system where the time delay between a pair of an excitation signal and its stimulated signal interfered or affected by the excitation signal is used for carrying out a variety of signal processing operations. The examples of these operations include but are not limited to digital pre-distortion (DPD), antenna calibration, direction of arrival (DOA) estimation, voice echo cancellation for cell phone, and noise cancellation in a sonar system or a radar system.

The method 800 begins with step 810 where an apparatus for estimating the time delay, e.g., the TDE unit as shown or a computing device at baseband (BB) side as shown in FIG. 3, determines a predictive offset for aligning an excitation signal, e.g., TX signal, with a stimulated signal, e.g., RX signal. As noted above, it expects that the TX and RX signals approximately synchronize with each other when the RX signal is shifted roughly with the predictive offset.

In some embodiments, the TDU unit determines whether any previously determined time delay between the excitation signal and the stimulated signal is available, and if available, the previously determined time delay is set as the predictive offset; otherwise, an initial offset is set as the predictive offset.

Then the method 800 proceeds to step 820 where the TDE unit acquires the cross-correlation between the TX signal and the RX signal which is shifted roughly with the predictive offset as determined at step 810. That is, the RX signal is shifted with a quantity equal to the predictive offset, slightly less than the predictive offset or slightly more than the predictive offset.

The method 800 further proceeds to step 830 where the TDE unit determines the time delay from the cross-correlation acquired at step 820.

Optionally, after step 830, the method 800 further proceeds to step 840 where the TDE unit sets the time delay determined at step 830 as the predictive offset for subsequent time delay estimation.

Optionally, the method 800 further proceeds to step 850 where the TDE unit judges whether the subsequent time delay estimation shall be performed. If yes, the method 800 proceeds to step 810; otherwise, the method 800 ends.

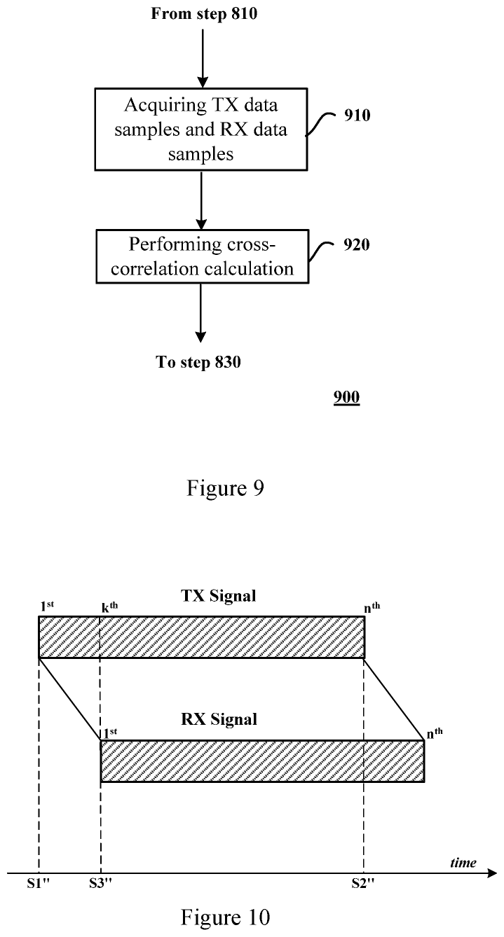

FIG. 9 is a schematic flow chart illustrating an exemplary method 900 according to one or more embodiments of the present disclosure. The exemplary method 900 is available for e.g., acquiring the cross-correlation between the TX signal and the RX signal roughly with the predictive offset at step 820.

The method 900 begins with step 910 where the TDU unit acquires a plurality of data samples of the TX signal and a plurality of data samples of the RX signal, which are the portion of the RX signal correlated with the TX signal.

In some embodiments, the TX and RX signals may be acquired in a “synchronous” mode. To be specific, the TDE unit captures and stores the TX and RX signals synchronously. Taking FIG. 6 as an example, the TX and RX signals start at the same time point but have different lengths, i.e., n and m respectively. When the location corresponding to the k^{th} data sample of the RX signal is selected as the start point of the correlated portion, the data samples of the RX signal from k^{th} to (k+n−1)^{th} are considered as the plurality of data samples of the RX signal, and the width of the delay window is n. Thus, the plurality of data samples of the RX signal can be acquired by intercepting or cutting the RX signal from its k^{th} data sample to its (k+n−1)^{th} data sample. Meanwhile, the data samples of the TX signal from 1^{st} to n^{th} are considered as the plurality of data samples of the TX signal.

In another example as shown in FIG. 7, the TX and RX signals start at the same time point and also ends the same point and thus have the same length, i.e., n. When the location corresponding to the k^{th} data sample of the RX signal is selected as the start point of the correlated portion, the data samples of the RX signal from k^{th} to n^{th} are considered as the plurality of data samples of the RX signal, and thus the width of the delay window is (n−k+1). Likewise, the plurality of data samples of the RX signal can be acquired by intercepting or cutting the RX signal from its k^{th} data sample to its (n−k+1)^{th} data sample. Moreover, the data samples of the TX signal from 1^{st} to (n−k+1)^{th} are considered as the plurality of data samples of the TX signal.

In some embodiments, the TX and RX signals may be acquired in an “asynchronous” mode. In this mode, the acquisition of the RX signal begins with a delay from the start point of acquiring the TX signal. The delay may be roughly equal to the predictive offset. FIG. 10 illustrate an example of the acquisition of the TX and RX signals according to one or more embodiments of the present disclosure. As shown therein, the TX signals start at the time points S1″ and ends at time point S2″, and the RX signals starts at the time points S3″ and ends at time point S4″. Only for illustrative purpose, the lengths of the TX and RX signals are assumed to be n. When the predictive offset is set to be k data samples, the interval between the point S1″ and the point S3″, i.e., the delay, is equal to k. Accordingly, the data samples of the TX signal from 1^{st} to n^{th} are considered as the plurality of data samples of the TX signal, and the data samples of the RX signal from k^{th} to (k+n−1)^{th} are considered as the plurality of data samples of the RX signal, and the width of the delay window is n. Thus, the plurality of data samples of the RX signal can be acquired by delaying the acquisition of the RX signal roughly by the predictive offset, e.g. k data samples. Namely, the delay may be equal to k, less than k, or more than k.

Then the method 900 proceeds to step 920 where the TDE unit performs the cross-correlation calculation on the plurality of data samples of the TX and RX signals within the delay window as acquired at step 910. In the examples as shown in FIGS. 6 and 10, the TDU unit calculates a cross-correlation spectrum from the data samples of the RX signal from k^{th} to (k+n−1)^{th} and the data samples of the TX signal from 1^{st} to n^{th}, and in the example of FIG. 7, it calculates the cross-correlation spectrum from the data samples of the RX signal from k^{th} to n^{th} and the data samples of the TX signal from 1^{st} to (n−k+1)^{th}. It should be noted that the cross-correlation may be in the form of power correlation or signal correlation in a baseband or an intermodulation signal.

In some embodiments, the cross-correlation calculation is performed in an iterative manner and thus the spectrum represents the accumulation of the cross-correlation between the data samples of the TX signal and the data samples of the RX signal.

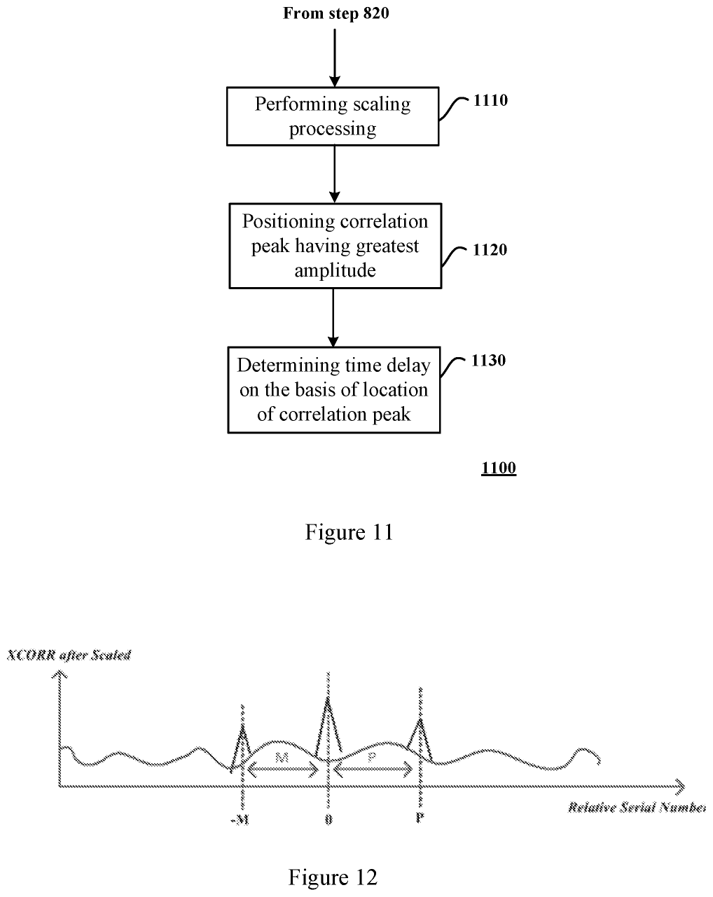

FIG. 11 is a schematic flow chart illustrating an exemplary method 1100 according to one or more embodiments of the present disclosure. The exemplary method 1100 is available for e.g., determining the time delay at step 830.

The method 1100 begins with step 1110 where the TDU unit performs a scaling processing on the cross-correlation spectrum acquired at step 920. FIG. 12 illustrates an exemplary scaled cross-correlation spectrum where the horizontal axis represents the data samples of the RX signal and the vertical axis represents the cross-correlation values after scaled. As noted above, a delay window can be defined in terms of the serial numbers of data samples relative to a reference point corresponding to the predictive offset. In the example as shown in FIG. 12, the reference point has a relative serial number of 0, and the left and right endpoints of the delay window have relative serial numbers of-M and P respectively.

Then the method proceeds to step 1120 where the TDU unit positions a correlation peak having the greatest amplitude in the scaled cross-correlation spectrum, e.g., as shown in FIG. 12.

The method further proceeds to step 1130 where the TDU determines the time delay on the basis of the location of the correlation peak as positioned at step 1120.

In some embodiments, the time delay D may be determined as follows:

$$D = {D}_{p} + Δ \qquad ( 1 )$$

Dₚ represents the predictive offset and Δ represents the location of the correlation peak having a greatest amplitude. For illustrative purpose, if this correlation peak is located at a data sample later than the reference point by L data samples, the delay D is equal to (Dₚ+L); if the correlation peak is located at a data sample earlier than the reference point by L′ data samples, the delay D is equal to (Dₚ−L′).

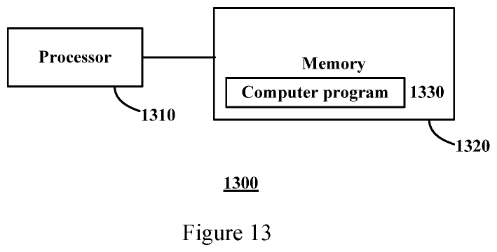

FIG. 13 is a block diagram illustrating an apparatus for estimating a time delay between an excitation signal and a stimulated signal correlated with the excitation signal in a communication or measurement system according to one or more embodiments of the present disclosure. The TDU unit as described above may be implemented as the apparatus as shown in FIG. 13.

With reference to FIG. 13, the apparatus 1300 may comprise at least one processor 1310 and memory 1320 configured to store a computer program 1330 comprising computer instructions executable by the at least one processor 1310, whereby the at least one processor 1310 is configured to perform the steps in the exemplary methods as described above.

Note that, the apparatus 1300 may be implemented as hardware, software, firmware and any combination thereof. For example, the apparatus 1300 may include a plurality of units, circuities, modules or the like, each of which may be used for performing one or more steps of the exemplary methods, or one or more steps as described above.

According to one aspect of the present disclosure, it provides a computer program product being embodied in a computer readable storage medium and comprising computer instructions for performing one or more steps of the exemplary methods, or one or more steps as described above.

An electronic device stores and transmits (internally and/or with other electronic devices) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals-such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical interfaces to establish connections (to transmit and/or receive code and/or data using propagating signals) with other electronic devices. One or more parts of an embodiment of the present disclosure may be implemented using different combinations of software, firmware, and/or hardware.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more signal processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed signal processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method for estimating a time delay between an excitation signal and a stimulated signal correlated with the excitation signal in a communication or measurement system, comprising:
acquiring a predictive offset with which the stimulated signal is predicted to be approximately synchronized with the excitation signal;
acquiring cross-correlation between the excitation signal and the stimulated signal shifted roughly with the predictive offset; and
determining the time delay from the cross-correlation.

2. The method according to claim 1, further comprising:
setting the time delay as the predictive offset for subsequent time delay estimation.

3. The method according to claim 1, wherein the time delay is used for carrying out one of passive intermodulation cancellation (PIMC) in a base station, digital pre-distortion (DPD), antenna calibration, direction of arrival (DOA) estimation, voice echo cancellation for cell phone, and noise cancellation in a sonar system or a radar system.

4. The method according to claim 1, wherein the step of acquiring the predictive offset comprising:
if any previously determined time delay between the excitation signal and the stimulated signal is available, setting the previously determined time delay as the predictive offset; and
if no previously determined time delay between the excitation signal and the stimulated signal is available, setting an initial offset as the predictive offset.

5. The method according to claim 4, wherein the initial offset is a passive intermodulation (PIM) loop delay measured at transceiver array boundary (TAB) or Radiated Interface Boundary (RIB) or is determined based on a loop delay range.

6. The method according to claim 1, wherein the step of acquiring the cross-correlation comprising:
acquiring a first plurality of data samples of the excitation signal starting at a first point and a second plurality of data samples of the stimulated signal, wherein the second plurality of data samples corresponds to a delay window starting at a second point being later than the first point roughly by the predictive offset; and
performing cross-correlation on the first plurality of data samples and the second plurality of data samples over the delay window.

7. The method according to claim 6, wherein the length of the excitation signal is less than or equal to the length of the stimulated signal; or
wherein the second point is selected so as to make the delay window cover one or more possible PIM sources.

8. The method according to claim 6, wherein the step of acquiring comprising:
capturing the excitation signal and the stimulated signal synchronously;
intercepting the stimulated signal from the second point to acquire the second plurality of data samples corresponding to the delay window; or
wherein the step of acquiring comprises:
capturing the first plurality of data samples;
capturing the stimulated signal with a delay roughly equal to the predictive offset so as to acquire the second plurality of data samples corresponding to the delay window.

9. (canceled)

10. (canceled)

11. The method according to claim 1, wherein the cross-correlation is in the form of power correlation or signal correlation in a baseband or an intermodulation signal.

12. The method according to claim 11, wherein the step of determining the time delay comprising:
performing a scaling processing on the cross-correlation;
positioning a correlation peak having the greatest amplitude in the scaled cross-correlation; and
determining the time delay on the basis of a location corresponding to the correlation peak having the greatest amplitude and in relation to the predictive offset.

13. An apparatus for estimating a time delay between an excitation signal and a stimulated signal correlated with the excitation signal in a communication or measurement system, comprising:
memory configured to store a computer program comprising computer instructions; and
at least one processor coupled to the memory and configured to execute the computer instructions to:
acquire a predictive offset with which the stimulated signal is predicted to be approximately synchronized with the excitation signal;
acquire cross-correlation between the excitation signal and the stimulated signal shifted roughly with the predictive offset; and
determine the time delay from the cross-correlation.

14. The apparatus according to claim 13, wherein the at least one processor is further configured to execute the computer instructions to:
set the time delay as the predictive offset for subsequent time delay estimation.

15. The apparatus according to claim 13, wherein the at least one processor is further configured to execute the computer instructions to:
output the time delay to a processing device for carrying out one of passive intermodulation cancellation (PIMC) in a base station, digital pre-distortion (DPD), antenna calibration, direction of arrival (DOA) estimation, voice echo cancellation for cell phone, and noise cancellation in a sonar system or a radar system.

16. The apparatus according to claim 13, wherein the at least one processor is configured to execute the computer instructions to acquire the predictive offset in the following manner:
if any previously determined time delay between the excitation signal and the stimulated signal is available, setting the previously determined time delay as the predictive offset; and
if no previously determined time delay between the excitation signal and the stimulated signal is available, setting an initial offset as the predictive offset; or
wherein the at least one processor is configured to execute the computer instructions to acquire the cross-correlation in the following way:
acquiring a first plurality of reference data samples starting at a first start point of the excitation signal and a second plurality of inspired data samples starting at a second start point of the stimulated signal, wherein the second start point is later than the first start point roughly by the predictive offset; and
performing a cross-correlation calculation on the first plurality of reference data samples and the second plurality of inspired data samples over a time window.

17. The apparatus according to claim 16, wherein the initial offset is a passive intermodulation (PIM) loop delay measured at transceiver array boundary (TAB) or Radiated Interface Boundary (RIB) or is determined based on a loop delay range; or
wherein the first plurality of reference data samples have the same number as the second plurality of inspired data samples.

18. (canceled)

19. (canceled)

20. The apparatus according to claim 18, the acquiring of the first plurality of reference data samples and the second plurality of inspired data samples is performed by capturing the first plurality of reference data samples and the second plurality of inspired data samples synchronously; or
the acquiring of the first plurality of reference data samples and the second plurality of inspired data samples is performed by:
capturing the first plurality of reference data samples; and
capturing the second plurality of inspired data samples with a delay roughly equal to the predictive offset.

21. (canceled)

22. The apparatus according to claim 18, wherein the time window is selected so as to cover possible PIM source locations.

23. The apparatus according to claim 13, wherein the cross-correlation is in the form of power correlation or signal correlation in a baseband or an intermodulation signal.

24. The apparatus according to claim 23, wherein the at least one processor is configured to execute the computer instructions to determine the time delay in the following way:
performing a scaling processing on the cross-correlation;
positioning a correlation peak having the greatest amplitude in the scaled cross- correlation; and
determining the time delay on the basis of a location corresponding to the correlation peak having the greatest amplitude and in relation to the predictive offset.

25. (canceled)

26. A computer program product for estimating a time delay between an excitation signal and a stimulated signal correlated with the excitation signal in a communication or measurement system, the computer program product comprising instructions, when carried out by a processor, causes:
acquiring a predictive offset with which the stimulated signal is predicted to be approximately synchronized with the excitation signal;
acquiring cross-correlation between the excitation signal and the stimulated signal shifted roughly with the predictive offset; and
determining the time delay from the cross-correlation.
